(19) United States
(12) Patent Application Publication
(10) Pub. No.: US 2025/0319561 A1
(43) Pub. Date: Oct. 16, 2025

(54) Automatic Tool Changer System

(71) Applicant: Arjun Mehta, Fremont, CA (US)

(72) Inventor: Arjun Mehta, Fremont, CA (US)

(73) Assignee: CHEFFY INC., San Francisco, CA (US)

(21) Appl. No.: 19/020,723

(22) Filed: Jan. 14, 2025

Related U.S. Application Data
(60) Provisional application No. 63/621,567, filed on Jan. 16, 2024.

(51) Int. Cl. B23Q 3/155

(52) U.S. Cl. CPC B23Q 3/15553

(57) ABSTRACT

Embodiments of an automatic tool changer system are described. An automatic tool changer can be mounted on a robot or machine to enable automatic switching between various tools. Embodiments of an automatic tool changer system described in this invention allow infinite rotation of the tool. The system comprises an automatic tool changer and a mating tool coupler. The automatic tool changer includes a body with a passageway and at least one port housing a detent member. The detent member is movable between a locked position for engaging a tool and an unlocked position for releasing it. A solenoid is configured to drive the detent member directly or drive an engagement actuator that facilitates the detent members' movement. The mating tool coupler includes a pocket configured to receive the body of the automatic tool changer and one or more indentations that align with the detent member to secure the tool during operation. The system further includes optional rotational blockers and a tool base for stabilizing and enabling more complex tools, cavities for additional sensors, and features such as a tapered surface for alignment, a rotary seal for environmental protection, and a spring alignment structure for biasing components into position. The invention enables automatic tool exchange in a quiet, compact form factor while allowing for continuous rotation of components and broad adaptability to various tool designs.

### TECHNICAL FIELD

The present invention relates to a mechanism for automatically changing the tool used by a machine or robot without requiring human intervention.

### DESCRIPTION OF THE RELATED ART

In the field of robotics and automation, there is a growing need for machines that can perform a variety of tasks without requiring a separate machine for each task. This is typically accomplished with a tool changing device or a gripping device which allows a machine to grasp the appropriate tool for its current task and then swap to another tool for the next task. For example, a machine may use a cutting tool to cut an object, followed by a different tool to lift and transport the object. Existing solutions typically consist of two components: a tool changer unit and a mating tool coupler. The tool changer unit is mounted on the machine or robot end effector, and the tool coupler is attached to the tool. When the tool changer unit and tool coupler are joined and locked together, the machine has control of the tool. When the tool is no longer needed, the tool changer unit and tool coupler are unlocked from each other. In this manner, a machine only requires an initial installation of the tool changer unit after which it can utilize any tool that incorporates the mating tool coupler. Furthermore, switching between tools can be done automatically, without human intervention. The locking and unlocking mechanisms of these tool couplers typically utilize pneumatic power, hydraulic power, or electric power.

Solutions that utilize pneumatic power require air compressors which are loud and take up a lot space. Hydraulic powered tool changers require sophisticated equipment such as pumps, hydraulic fluid, and control valves which take up space and can be messy during maintenance. These are not suitable for applications that require low noise and a small footprint, such as in a home or office.

Electrically powered solutions, such as motorized grippers or electromagnetic tool changers, are gaining popularity for applications where a smaller form factor and quiet operation outweigh the additional tool gripping force provided by pneumatic and hydraulic power.

However, these solutions have a key limitation: they do not allow the tool to be rotated continuously and indefinitely. Instead, they have a limited range of motion preventing them from rotating beyond a single revolution, often less. This is because the rotating portion of the tool changer unit requires wires or tubes running through it to power the locking/unlocking mechanism, and endless spinning would cause those wires to become tangled and break.

There are a variety of tasks where this limitation becomes prohibitive, such as when spinning a cutting blade or disc, rotating gears in a gearbox, rotating a lead screw, mixing, blending, stirring, and many other operations. In these examples, the task could not be performed if the machine could only rotate back and forth without spinning endlessly.

Furthermore, since a separate mating tool coupler needs to be used for each tool, the cost to support an automatic tool changing system can be high. Further adding to this cost is the high degree of repeatability and precision needed by the machine or robot, since it must precisely align the tool changer unit to the tool coupler to successfully lock the two together.

Thus, there is a need for a tool changing device that is compact, quiet, provides the freedom to spin a tool endlessly, supports a low-cost, easy to manufacture tool coupler, and supports a wide tolerance for how precisely aligned the base unit and tool coupler need to be in order to successfully lock.

### SUMMARY OF THE INVENTION

The present disclosure provides embodiments of an automatic tool changer system that includes an automatic tool changer and, optionally, a mating tool coupler. The automatic tool changer is configured to be mounted to a rotational actuator, such as a motor or robotic end effector, and enables tools incorporating a mating tool coupler to be locked and unlocked automatically. This system facilitates automatic tool changes in a quiet, compact footprint, while also being capable of infinite rotation of the tool, thereby opening the doors for automation in a broad range of applications.

In some embodiments, the automatic tool changer comprises a body with a passageway and one or more ports through which detent members can extend. The detent members, controlled by an engagement actuator, are movable between locked and unlocked positions, allowing the automatic tool changer to securely engage or release a mating tool coupler. The engagement actuator is driven by solenoid means mounted separately from the body, enabling independent rotational movement of the body without requiring wires or power sources within the rotating components. This design allows continuous rotation of the body and therefore continuous rotation of the tool that is locked to the automatic tool changer. Additionally, the solenoid means results in the automatic tool changer system being much quieter than other types of tool changer systems that use pneumatic power.

The body of the automatic tool changer may include various optional features to enhance functionality and tool changing performance. For instance, a tapered surface facilitates alignment of the mating tool coupler with the automatic tool changer even when they are not precisely aligned. A shaft mounting interface accommodates robotic end effector shafts of different shapes, and can be secured using methods such as press-fit, adhesive bonding, or set screws. Additional design elements, such as lids for enclosing internal components, spring alignment structures, reinforced materials at critical interfaces, and channels to allow components to recede into each other, improve durability, assembly efficiency, alignment accuracy, and compactness of the overall design.

The mating tool coupler, designed to pair with the automatic tool changer, features a pocket for receiving the tool changer body and indentations for engaging the detent members. Some embodiments include a tapered surface for facilitating alignment with the automatic tool changer. In some embodiments, the mating tool coupler may include a shaft that runs through a tool base to provide support for more complex tools, or reinforced mounting features to enhance durability.

To support more complex tools such as robotic grippers that may require some parts of the tool to move while other parts of the tool remain stationary, or to support tools that may benefit from more precision and less wobble, the automatic tool changer system may include a tool base, rotation blockers, and bearings. Rotation blockers stabilize the tool base relative to the automatic tool changer, while bearings and retaining features allow the mating tool coupler to rotate independently within the tool base. These features collectively enable the system to handle a wide range of tools, from simple end effectors to sophisticated robotic mechanisms.

The present disclosure also contemplates various alternative embodiments and configurations, such as solenoid-driven magnetic detent members, compact designs with integrated channels for reduced height, and modular components for easy customization. The system's modularity and versatility make it suitable for a diverse range of robotic and automated systems.

This invention provides a modular, versatile, and highly adaptable automatic tool changer system that enhances the capability of robotic and automated systems.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a front perspective view of an exemplary embodiment of an automatic tool changer and mating tool coupler according to the present disclosure;

FIG. 2 is a front view of an exemplary embodiment of an automatic tool changer and mating tool coupler according to the present disclosure;

FIG. 3 is a front perspective view of an exemplary embodiment of an automatic tool changer and mating tool coupler according to the present disclosure;

FIG. 4 is a right side sectional view of the exemplary embodiment of an automatic tool changer and mating tool coupler depicted in FIG. 2, along the cross-sectional line 27, with the automatic tool changer in the locked position.

FIG. 5 is a right side sectional view of the exemplary embodiment of an automatic tool changer and mating tool coupler depicted in FIG. 2, along the cross-sectional line 27, with the automatic tool changer in the unlocked position.

FIG. 6 is a top perspective view of an exemplary embodiment of an automatic tool changer body;

FIG. 7 is a bottom perspective view of an exemplary embodiment of engagement actuator means, also referred to as a sliding blocker in some embodiments, and magnet according to the present disclosure;

FIG. 8 is an exploded view of an exemplary embodiment of an automatic tool changer;

FIG. 9 is a bottom perspective view of an exemplary embodiment of an automatic tool changer and mating tool coupler and tool base, in which the automatic tool changer is not locked to the mating tool coupler;

FIG. 10 is a bottom perspective view of an exemplary embodiment of an automatic tool changer and mating tool coupler and tool base, in which the automatic tool changer is locked to the mating tool coupler;

FIG. 11 is an exploded view of an exemplary embodiment of a mating tool coupler and tool base;

FIG. 12 is a top perspective view of an exemplary embodiment of a tool base;

FIG. 13 is a top perspective view of an exemplary embodiment of a mating tool coupler;

FIG. 14 is a right side sectional view of the exemplary embodiment of a mating tool coupler and tool base depicted in FIG. 9, along the cross-sectional line 28.

### DETAILED DESCRIPTION

The present disclosure provides embodiments of an automatic tool changer system, which includes an automatic tool changer 1 and a mating tool coupler 18. The automatic tool changer 1 is typically mounted to rotational actuator means 16, such as a motor or robot end effector, and the mating tool coupler 18 is typically mounted to or built into the design of a tool. The mating tool coupler 18 can be locked and unlocked from the automatic tool changer 1, allowing for the automatic tool changer 1 to change between tools that incorporate the mating tool coupler 18. In some embodiments, the mating tool coupler 18 is augmented by a tool base 21, which adds additional stabilization and support for more complex tools. In alternative embodiments, the automatic tool changer 1 may be used without the mating tool coupler 18, interfacing instead with third-party tool holders or robotic systems. Similarly, the mating tool coupler 18 and tool base 21 may function independently or with other tool changer mechanisms.

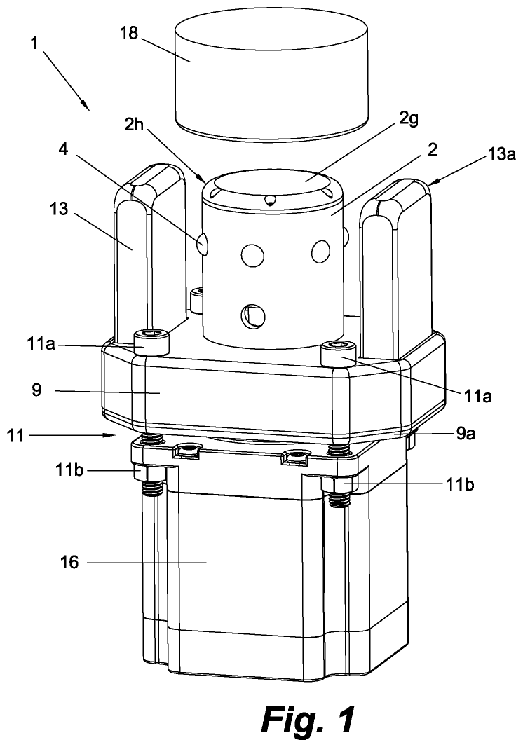

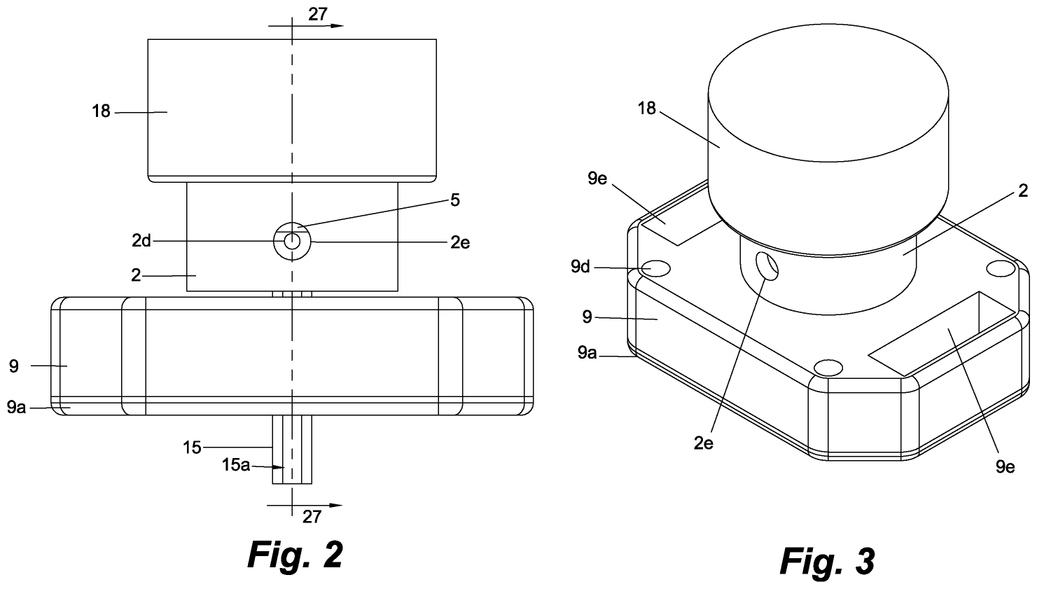

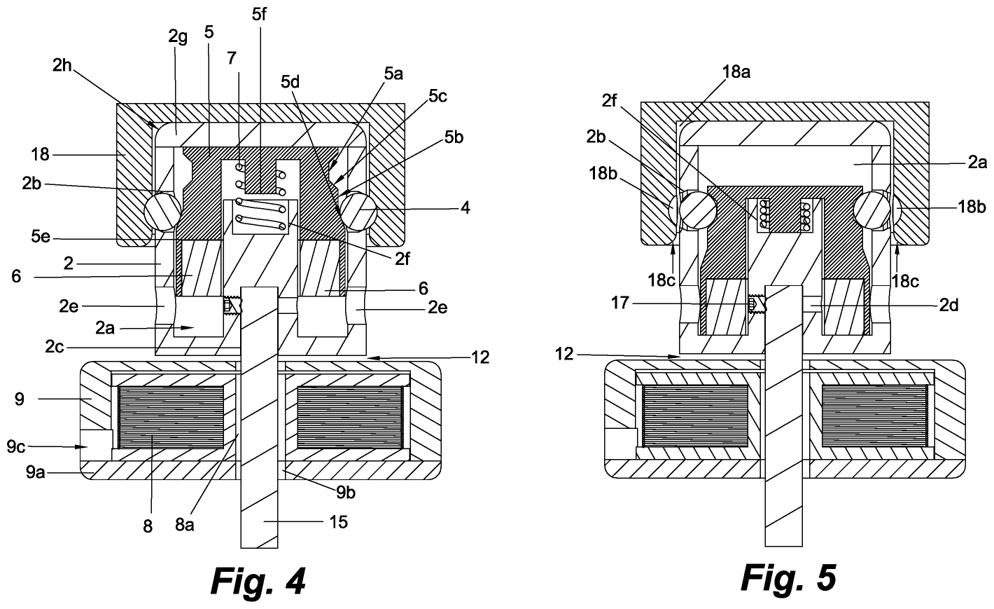

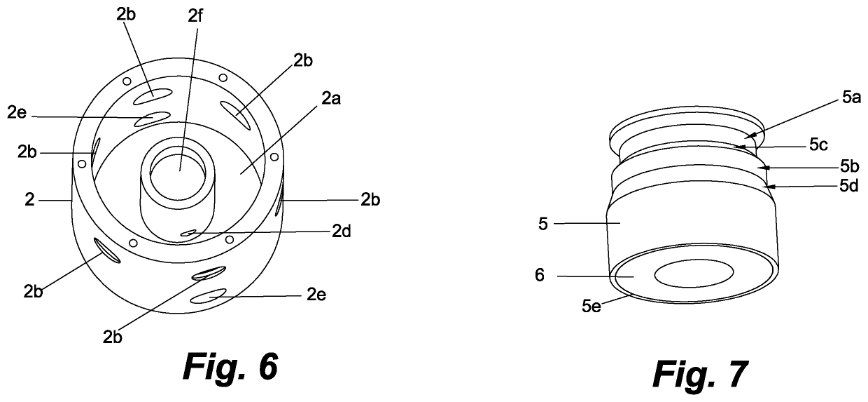

In the exemplary embodiment shown in FIGS. 1, 2, 3, 4, 5, 6, 7, and 8, an automatic tool changer 1 comprises a body 2 with a passageway 2a therein and at least one port 2b extending from said passageway 2a to the exterior of the body 2, a detent member 4 mounted for movement in said port 2b, said detent member 4 being movable in said port 2b between a locked position, as shown in FIG. 4, in which said detent member 4 is positioned outwardly in said port 2b and an unlocked position, as shown in FIG. 5, in which said detent member 4 is retracted inwardly of said port 2b, engagement actuator means 5 engageable with said detent member 4 and moveable to a first position, as shown in FIG. 4, within said passageway 2 to urge said detent member 4 to said locked position, said engagement actuator means 5 being movable to a second position, as shown in FIG. 5, in which said engagement actuator means 5 allows said detent member 4 to be retracted to said unlocked position, and solenoid means 8 mounted separately from said body 2 for driving said engagement actuator means 5 to cause said engagement actuator means 5 to switch between a locked and/or unlocked position, such that said body 2 can move independently from said solenoid means 8.

In some embodiments, the automatic tool changer 1 comprises a plurality of detent members 4 corresponding to a plurality of ports 2a, thereby providing more stability and evenly distributed pressure on the mating tool coupler 18.

In some embodiments of the body 2, the at least one port 2a may be tapered to prevent the detent member 4 from falling out of the body 2.

In some embodiments of the body 2, the body 2 consists of a single piece, which may facilitate ease of manufacturing. In other embodiments, the body 2 may consist of multiple pieces joined together, which may facilitate easier assembly.

In some embodiments, the body 2 may include a lid 2g to enclose engagement actuator means 5. Said lid 2g may be attached to the body 2 via a fastening system 3, such as screws. The lid 2g may also have a tapered surface 2h to facilitate auto-alignment during entry into the mating tool coupler 18. If the lid is absent from the design, the body 2 may incorporate this tapered surface 2h directly.

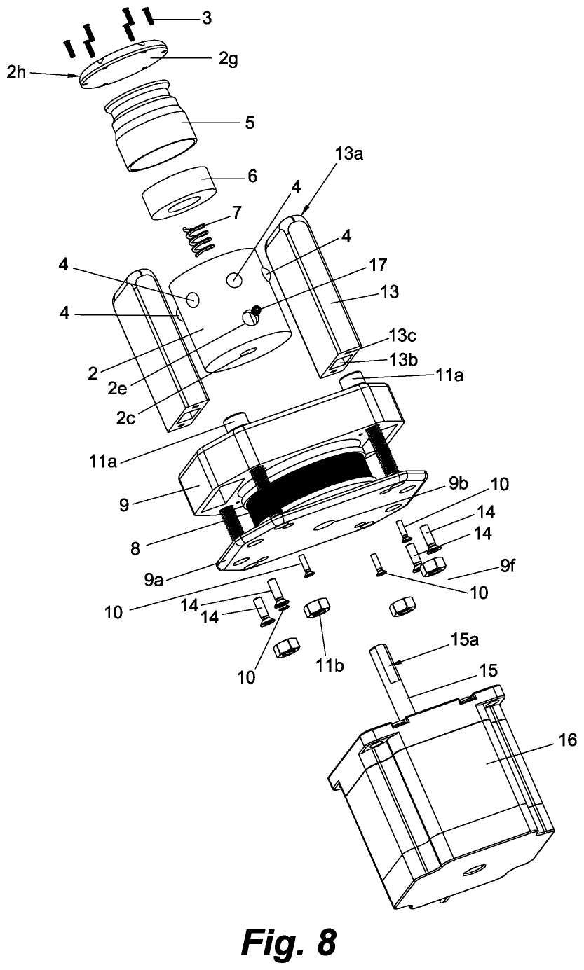

In some embodiments, the body 2 may also be configured to be mounted to a shaft 15, such as that of the rotational actuator means 16, via a mounting interface 2c. As shown in FIG. 8, the mounting interface 2c may include a keyed slot shape to receive a shaft 15 with a corresponding shape, such as a D-shaped or hexagonal cross-section, to provide rotational locking. In alternative embodiments, the mounting interface 2c may be adapted to secure the shaft 15 using adhesive bonding or press-fit engagement, allowing flexibility in manufacturing and assembly. The mounting interface 2c may be reinforced with a different material compared to the body, such as metal, to provide additional strength and support against torsional forces from the shaft 15 acting upon the body 2. In certain situations, this allows the body 2 to be manufactured out of a more cost-effective material, such as injection-molded plastic, while the mounting interface 2c is manufactured out of a more expensive material.

In some embodiments, as shown in the example configuration in FIGS. 1 through 8, the body 2 may include a threaded hole 2d for receiving a set screw 17 that locks the shaft 15 to the body 2 and prevents the shaft 15 from sliding out or rotating independently from the body 2. In some embodiments, in order make the height of the body 2 as compact as possible, it may be beneficial for the threaded hole 2d to be hidden behind the movement path of the engagement actuator means 5, making it difficult to install or remove the set screw 17. Therefore, an additional hole 2e may be present in the exterior part of the body 2 to allow easy access to the set screw 17 for maintenance or assembly.

In some embodiments, the body 2 may include a spring alignment structure 2f configured to align a spring 7 which biases the engagement actuator 5 in a locked or unlocked position. In certain embodiments, the spring alignment structure 2f comprises a protruding pole extending from the body 2. In other embodiments, the spring alignment structure 2f may comprise a recessed area within the body 2. Both configurations serve to maintain the spring 7 in the correct orientation during operation.

In some embodiments, the detent member 4 may be curved in shape, such as in the shape of a sphere, which allows the automatic tool changer 1 to encourage alignment with a corresponding indentation 18b in the mating tool coupler 18 even when they are not perfectly aligned. Some embodiments may include multiple ports 2b on the body 2, and therefore multiple detent members 4 and multiple indentations 18b on the mating tool coupler 18, each corresponding with a port 2b on the body 2.

In some embodiments, the detent member 4 may be magnetic, such that the need for a separate engagement actuator means 5 is eliminated. In such embodiments, said solenoid means 8 directly controls the movement of the detent member 4 between a locked and unlocked position. As a result, in some embodiments, the solenoid means 8 may be mounted radially from the body 2 rather than axially, such as inside one or more rotational blockers 13, which will be described in more detail later.

In some embodiments, the engagement actuator means 5, referred to hereafter as the sliding blocker, slides inside the passageway 2a of the body 2 between a locked position and an unlocked position. In the unlocked position, a recess 5a in the sliding blocker 5 aligns with the detent member 4, allowing detent member 4 to recede into the sliding blocker 5 such that the detent member 4 is not forced to protrude out of the exterior surface of the body 2. In the locked position, a protruding surface 5b on the sliding blocker 5 aligns with the detent member 4, blocking the detent member 4 from receding and forcing it protrude outwardly through the port 2b in the body 2. In some embodiments, a transition slope 5c joins the recess 5a and protruding surface 5b to more easily facilitate the movement of the detent member 4 between its recessed and outward positions in the unlocked and locked state, respectively. In some embodiments, an additional sloping surface 5d extends past the protruding surface 5b and protrudes more outwardly than the protruding surface 5b to encourage the detent member 4 to protrude as outwardly as possible, thereby minimizing wobble and maximizing tightness between the automatic tool changer 1 and mating tool coupler 18.

In the exemplary configuration shown in FIGS. 4 and 5, the sliding blocker 5 includes a spring alignment structure 5f. The spring alignment structure 5f on the sliding blocker 5 and the spring alignment structure 2f on the body 2 function similarly but are located on different components and may take different shapes. The spring alignment structure 5f may, for example, be a protruding pole or an indentation, and serves to align the spring 7 in the correct orientation such that the sliding blocker 5 can be biased into a particular position.

In the exemplary configuration shown in FIGS. 4, 5, 7, and 8, the sliding blocker 5 includes a magnet mounting interface 5e for receiving one or more magnets 6 which reacts to the magnetic field generated by the solenoid means 8. In some embodiments, the magnetic mounting interface 5e may include a slot for press-fitting, gluing, or screwing the one or more magnets 5g to the sliding blocker 5. In alternative embodiments, the sliding blocker 5 itself may be magnetic, avoiding the need for a separate magnet 6 and magnet mounting interface 5e.

In some embodiments, to minimize the height of the automatic tool changer 1 and keep it as compact as possible, the sliding blocker 5 may include a channel 5g to allow features in the body 2, such as the shaft mounting interface 2c, to recede into the sliding blocker 5 when in certain positions.

In some embodiments, the magnet 6 may be a ring magnet, whereas in other embodiments, one or more magnets 6 may be present. A ring magnet is preferred as it provides a more dense magnetic field for the same available volume in the magnetic mounting interface 5e. The inner diameter of the ring magnet can also be chosen to match the diameter of the channel 5g in some embodiments of the sliding blocker 5, thereby maximizing the magnetic field while still enabling features in the body 2 to recede into the channel 5g in the sliding blocker 5, allowing the automatic tool changer 1 to be as compact as possible. While multiple magnets can be used, a ring magnet is also easier to install. The polarity of the magnet 6 or magnets 6 are oriented such that it is actuatable by the solenoid means 8. A strong magnet, such as an N52 neodymium magnet, is preferred over a weaker magnet, since a stronger magnet can move more forcefully and allows for a stronger spring 7 to be used or allows for a weaker solenoid means 8 to be used, or both. A stronger spring 7 allows the sliding blocker 5 to be more reliably biased into a locked or unlocked position, depending on the design. For example, if the spring 7 biases the sliding blocker 5 into a locked position, a stronger spring causes the automatic tool changer 1 to more tightly lock to the mating tool coupler 18. If a weaker solenoid means 8 can be used, the current flowing through the solenoid means is less, which makes for the solenoid means to be more energy efficient or have a less chance of overheating.

Turning to the exemplary configuration shown in FIGS. 1, 2, 3, 4, 5, 8, and 9, the solenoid means 8 may have a hole 8a to allow the shaft 15 through it, allowing the shaft 15 to spin independently of the solenoid means 8a. In some configurations, this hole may include a bearing.

In the exemplary configuration shown in FIGS. 1, 2, 3, 4, 5, 8, 9, 10, the solenoid means 8 is contained within a housing 9. In some embodiments, the housing 9 may include a lid 9a. The lid 9a may be attached to the housing 9 via a fastening system 10, such as screws, adhesive, or other joining means.

The housing 9 may also include a hole 9b to allow the shaft 15 through it, allowing the shaft 15 to spin independently of the housing 9. In some embodiments, the hole 9b may include a bearing. The housing 9 may also include a passageway 9c to allow wiring of external power to the solenoid means 8.

In some embodiments of the housing 9, a fastening system 11 may be employed for attaching the housing 9 to the rotational actuator means 16. In some embodiments, the fastening system 11 may include mounting screws 11a and nuts 11b. In other embodiments, adhesive may be used, or the housing 9 may be incorporated into the design of the rotational actuator means 16. The housing 9 may include one or more holes 9d to allow the screws 11a to pass through or be threaded inside. The housing 9 is mounted to the rotational actuator means 16 such that the shaft 15 of the rotational actuator means 16 is still able to rotate independently of the housing 9. This way, any wiring running to the automatic tool changer 1 does not get twisted when the shaft 15 rotates. As a result, when the body 2 is mounted to the shaft 15, there is a distinct separation or gap 12 between the body 2 and housing 9, allowing the body to move independently of the housing 9 and therefore solenoid means 8. Therefore, since the body can be actuated without any wires running through it, it can spin endlessly. In some embodiments, the gap 12 may include or be filled with a low friction surface such as a washer to aid in stability while still allowing smooth, infinite rotation.

In some embodiments, the automatic tool changer 1 may include one or more rotation blockers 13 to prevent unintentional rotation of the tool base 21. In some embodiments, the one or more rotation blockers 13 may be part of the housing 9. In other embodiments, the one or more rotation blockers 13 may be separate parts that are fastened to the housing 9 with a fastening system 14. In some embodiments, the housing 9 may include one or more slots 9e to receive the one or more rotation blockers 13. In some embodiments, the fastening system 14 may include screws that pass through one or more holes 9f in the housing 9 and fasten to corresponding threaded holes 13c in the one or more rotation blockers 13. Other embodiments of the fastening system 14 may include a press fit configuration or an adhesive to join the rotation blockers 13 to the housing 9.

In some embodiments, the one or more rotation blockers 13 may have a tapered surface 13a to facilitate alignment of the rotation blocker 13 with a corresponding slot 21b in the tool base 21.

In some embodiments, the one or more rotation blockers 13 may have a cavity 13b to house one or more sensors, such as a depth sensor or infrared sensor. In other embodiments, the one or more rotation blockers 13 may include a solenoid, such as to actuate detent members 4 that are magnetic.

The present disclosure also describes a mating tool coupler 18 that can be locked and unlocked with the automatic tool changer 1. The mating tool coupler 18 can be incorporated into or attached to a tool, thereby allowing the automatic tool changer 1 control of that tool when the automatic tool changer 1 is locked to the mating tool coupler 18.

In the exemplary configuration shown in FIGS. 1-5 and FIGS. 8-10, the mating tool coupler 18 includes a pocket 18a for receiving the body 1 of the automatic tool changer 1. The mating tool coupler 18 also includes one or more indentations 18b to receive the detent members 4 from the automatic tool changer 1, allowing the automatic tool changer 1 and mating tool coupler 18 to be locked together when the detent members 4 protrude into the indentations 18b. When the automatic tool changer 1 is in an unlocked position, the automatic tool changer 1 can slide in and out of the mating tool coupler 18. When the automatic tool changer 1 is docked in the mating tool coupler 18 and switched into a locked position, the automatic tool changer 1 becomes locked to the mating tool coupler 18.

In some embodiments, the one or more indentations 18b of the mating tool coupler 18 may be through holes rather than indentations, which may allow for easier manufacturing.

In some embodiments of the mating tool coupler 18, a tapered entry surface 18c on the mating tool coupler facilitates alignment with the automatic tool changer 1 by guiding the body 2 towards the pocket 18a.

The present disclosure also describes a tool base, which serves as a template around which different types of tools can be designed. Certain tools may require that one part of the tool be movable in relation to another part of the same tool. An example of such a tool includes a robotic gripper, in which the outer structure needs to be held in place while an actuator drives the gearbox within. In this example, incorporating only the mating tool coupler would not suffice, since spinning the mating tool coupler would cause the entire robotic gripper to spin as well. On the other hand, some tools may benefit from having more stability and less wobble than what the mating tool coupler can provide alone. For example, if a cutting disc is attached to the mating tool coupler, even though it may only need to spin to perform its function, any wobble between the mating tool coupler and the automatic tool changer may result in less precision than desired. To overcome these challenges, a tool base may be used in conjunction with the mating tool coupler so that the tool coupler can actuate part of the tool, while the tool base holds the other part of the tool in place and is stabilized in place by one or more rotation blockers on the automatic tool changer.

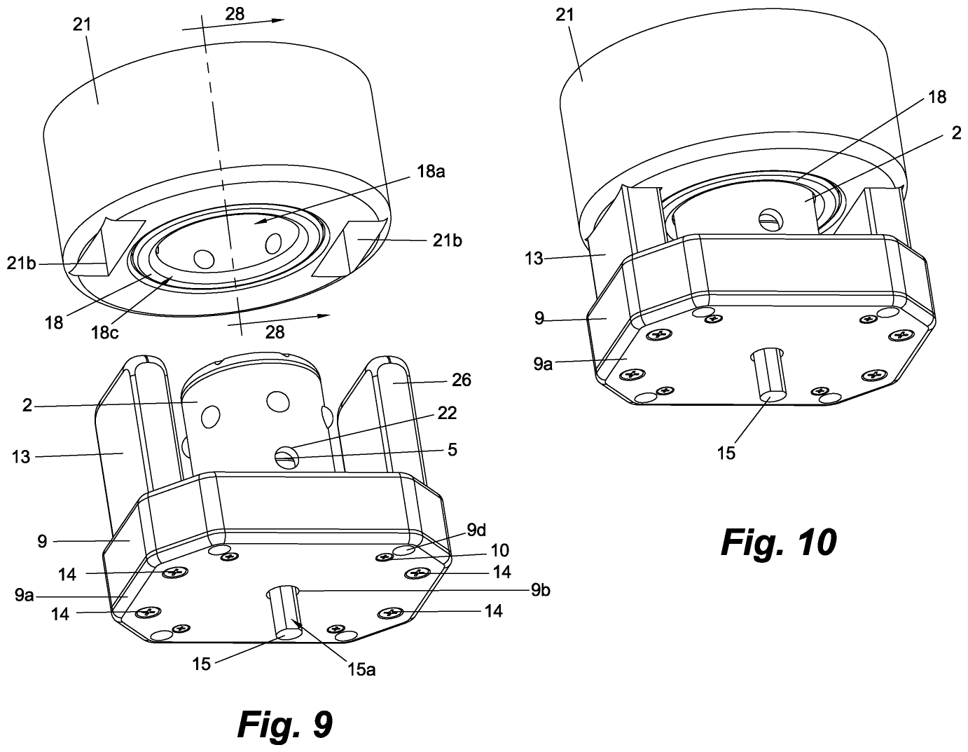

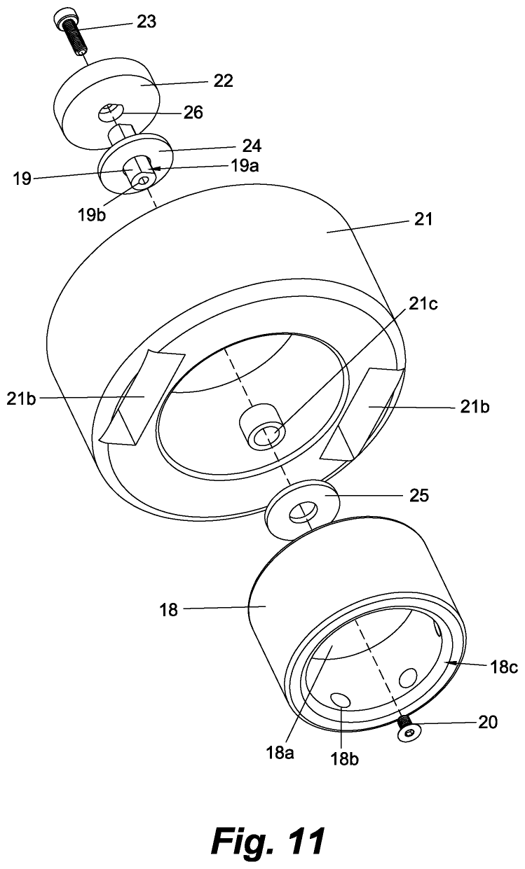

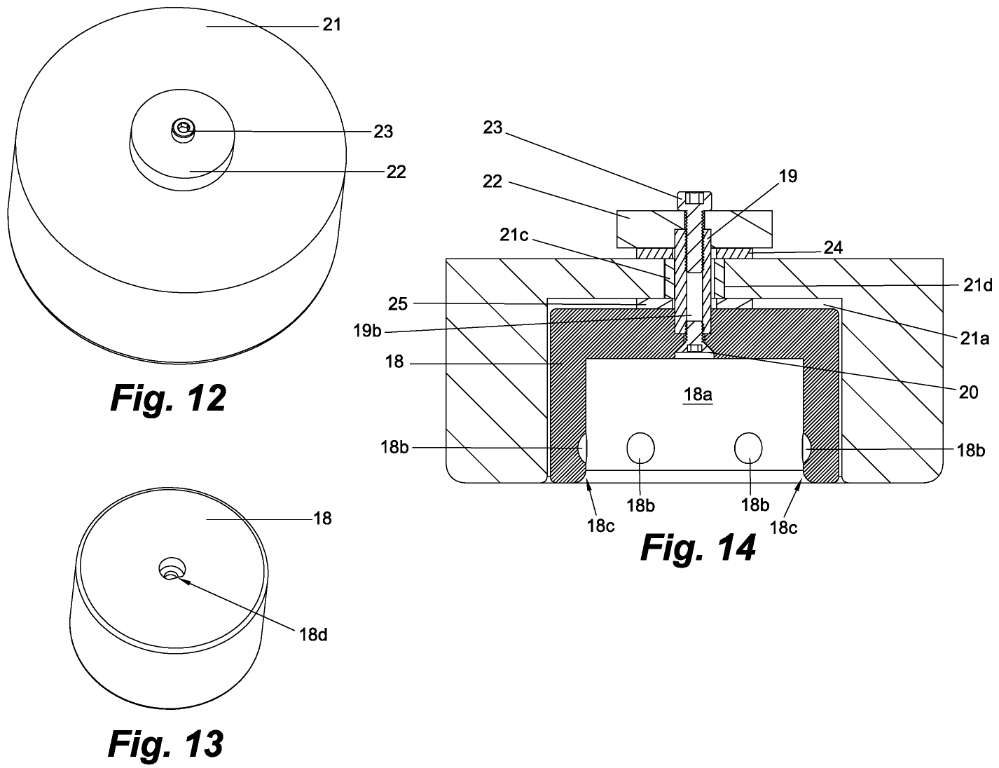

In the exemplary configuration shown in FIGS. 9 through 14, a tool base 21 includes a pocket 2a to receive a mating tool coupler 18, a bearing surface 21c inside the tool base 21, and one or more slots 21b to receive one or more rotation blockers. Note that not all features need to be included in every embodiment.

In some embodiments, the bearing surface 21c may be a standalone bearing that can be inserted into the tool base 21, and the tool base 21 may have a hole 21d to receive the bearing surface 21c. In other embodiments, the bearing surface 21c is built into the tool base 21. In other embodiments, the bearing surface 21c may incorporate a rotary seal to prevent the transfer of fluids or lubricant from one side of the tool base 21 to the other.

Next, some additional embodiments of the mating tool coupler 18 will be described in which the mating tool coupler 18 is configured to be assembled into the tool base 21.

As shown in FIGS. 9 through 14, an exemplary embodiment of the mating tool coupler 18 includes a slot 18d to receive a tool coupler shaft 19. In some embodiments, the slot 18d may have a keyed shape to match a keyed shape 19a on the tool coupler shaft 19 to enable rotational locking. The slot 18d may be sized for press-fitting the tool coupler shaft 19 to the mating tool coupler 18, attaching the tool coupler shaft 19 with adhesive, or other fastening means. In some embodiments, the mating tool coupler 18 may have a hole 18e for a screw 20, and the tool coupler shaft 19 may have a threaded hole 19b to allow the screw 20 to fasten the tool coupler shaft 19 to the mating tool coupler 18. In some embodiments, the slot 18d may be made of a different material or be reinforced with a different material, such as metal, to provide additional strength against torsional forces applied by the tool coupler shaft 19.

In some embodiments, the mating tool coupler 18 sits within the pocket 21a of the tool base 21, and the tool coupler shaft 19 passes through the bearing surface 21c in the tool base 21 so that the mating tool coupler 18 is rotatably jointed to the tool base 21. In some embodiments, a retaining feature 22 may be attached to the side of the tool coupler shaft 19 that passes through the tool base 21 so that the tool coupler shaft 19 and mating tool coupler 18 cannot fall out of the tool base 21. In some embodiments, the retaining feature 22 may be a flange with a fastening system 23. In alternative embodiments, the retaining feature 22 may be a locking collar with a set screw. In other embodiments, the retaining feature 22 may be built into the shape of the tool coupler shaft 19, such as a built-in flange or collar.

In an exemplary embodiment of the retaining feature 22 being a flange, the flange may include a keyed shape 26 to match with the keyed shape 19a of the tool coupler shaft 19, enabling rotational locking. In some embodiments of the fastening system 23 used in conjunction with the flange, the fastening system 23 may include a screw to attach the flange to the tool coupler shaft 19. In other embodiments, the fastening system 23 may include a press fit hole on the flange or an adhesive to join the flange and tool coupler shaft 19.

In some embodiments of the retaining feature 22, the retaining feature 22 may be attached to other parts of the tool, such as a cutting disc or the gear of a gearbox. This enables the automatic tool changer 1 to actuate the mating tool coupler 18 which in turn actuates that part of the tool.

In some embodiments of the tool base, the tool base may be in the form of a keyed shape, such as a D-shaped surface, so that the tool base may be correctly aligned with other mating surfaces.

What is claimed is:

1. An automatic tool changer comprising:
a body with a passageway therein and at least one port extending from said passageway to the exterior of said body;
a detent member mounted for movement in said port;
said detent member being movable in said port between a locked position in which said detent member is positioned outwardly in said port and an unlocked position in which said detent member is retracted inwardly of said port;
solenoid means mounted separately from said body for directly or indirectly driving said detent member between a locked and/or unlocked position, such that said body can move independently from said solenoid means.

2. The automatic tool changer according to claim 1, wherein the automatic tool changer comprises:
engagement actuator means engageable with said detent member and moveable to a first position within said passageway to urge said detent member to said locked position, said engagement actuator means being movable to a second position in which said engagement actuator means allows said detent member to be retracted to said unlocked position; and
solenoid means mounted separately from said body for driving said engagement actuator means to cause said engagement actuator means to switch between a locked and/or unlocked position, such that said body can move independently from said solenoid means.

3. The automatic tool changer according to claim 1, wherein said body includes a tapered surface, chamfered edge, or equivalent guiding feature configured to facilitate alignment with a mating tool coupler.

4. The automatic tool changer according to claim 1, wherein said body includes a shaft mounting interface configured to secure a shaft, the interface being adaptable to include:
a keyed slot to accommodate a shaft with a corresponding shape,
a press-fit connection for a frictional engagement, or
an adhesive bonding surface for permanent or temporary attachment.

5. The automatic tool changer according to claim 1, wherein said body includes a spring alignment structure configured to align a spring for biasing an engagement actuator into a locked or unlocked position, the spring alignment structure comprising at least one of:
a protruding pole extending from the body,
a recessed area within the body, or
an equivalent structure configured to maintain the spring in the correct orientation during operation.

6. The automatic tool changer according to claim 1, wherein the one or more detent members are curved in shape, the curved shape being configured to facilitate alignment with a mating tool coupler and/or to distribute locking forces evenly.

7. The automatic tool changer according to claim 1, wherein the one or more detent members are magnetic, the magnetic detent members being configured to move between a locked position and an unlocked position in response to a magnetic field generated by said solenoid means.

8. The automatic tool changer according to claim 1, wherein the engagement actuator comprises one or more magnets configured to interact with a magnetic field generated by said solenoid means to facilitate movement between the first and second positions.

9. The automatic tool changer according to claim 1, wherein the engagement actuator means includes a spring alignment structure configured to align a spring for biasing said engagement actuator into a locked or unlocked position, the spring alignment structure comprising at least one of:
a protruding pole extending from the body,
a recessed area within the body, or
an equivalent structure configured to maintain the spring in the correct orientation during operation.

10. The automatic tool changer according to claim 1, further comprising a housing, wherein the housing includes a hole extending through its center, the hole being configured to allow a shaft to pass through while enabling independent rotation of the shaft relative to the housing.

11. The automatic tool changer according to claim 1, further comprising one or more rotational blockers configured to engage with a portion of a tool, the rotational blockers being positioned to prevent rotation of the engaged portion of the tool relative to the automatic tool changer during operation.

12. The automatic tool changer according to claim 1, further comprising one or more rotational blockers, wherein at least one of the rotational blockers includes a cavity configured to incorporate at least one of:
a sensor, or
said solenoid means.

13. A mating tool coupler comprising:
a tool coupler body including a pocket configured to receive a portion of an automatic tool changer;
one or more indentations positioned within the pocket, the indentations being configured to engage with corresponding detent members of the automatic tool changer to lock the mating tool coupler to the automatic tool changer.

14. The mating tool coupler according to claim 13, wherein said tool coupler body includes a tapered surface, chamfered edge, or equivalent guiding feature configured to facilitate alignment of the pocket with the automatic tool changer.

15. The mating tool coupler according to claim 13, further comprising a tool coupler shaft extending from the tool coupler body.

16. The mating tool coupler according to claim 13, wherein the tool coupler body includes a reinforced section around the shaft to resist torsional forces during operation.

17. A tool base comprising:
a tool base body including a pocket configured to receive a mating tool coupler;
a bearing surface disposed within the pocket, the bearing surface configured to allow rotational movement of the mating tool coupler relative to the tool base; and
one or more slots configured to engage with rotational blockers from the automatic tool changer to stabilize the tool base and prevent rotation of a portion of the tool during operation.

18. The tool base according to claim 17, further comprising a retaining feature configured to secure a mating tool coupler within the pocket, the retaining feature being positioned to prevent unintentional separation of the mating tool coupler from the tool base during operation.

19. The tool base according to claim 17, wherein the tool base includes a rotary seal positioned to prevent the passage of liquids or debris between the mating tool coupler and the tool base during operation.

20. Tool base according to claim 17, wherein the tool base body takes a keyed shape to enable alignment with mating surfaces.
